(19) United States
(12) Patent Application Publication
(10) Pub. No.: US 2013/0241281 A1
(43) Pub. Date: Sep. 19, 2013

(54) ELECTRICAL CIRCUIT AND METHOD OF MANUFACTURING SAID ELECTRICAL CIRCUIT

(71) Applicants: Joffrey Brunelet, Saint Syrphorien (FR); Yves Stricot, Villepreux (FR)

(72) Inventors: Joffrey Brunelet, Saint Syrphorien (FR); Yves Stricot, Villepreux (FR)

(73) Assignee: FCI AUTOMOTIVE HOLDING, GUYANCOURT, FR (FR)

(21) Appl. No.: 13/812,754

(22) PCT Filed: Jul. 28, 2011
(86) PCT No.: PCT/IB11/02067

§ 371 Date: Mar. 28, 2013

(30) Foreign Application Priority Data
Jul. 29, 2010 (WO) IB2010/002569

(51) Int. Cl. B60R 21/017

(52) U.S. Cl. CPC B60R 21/017
USPC 307/10.1; 29/825

(57) ABSTRACT

The invention is related to an electrical circuit for an automotive electrical system. This electrical circuit comprises a filtering element for filtering a triggering signal, the filtering element having a first conductor for connecting to a ground, a squib intended to trigger a SRS device upon reception of the triggering signal, the squib having a ground, wherein the first conductor is connected to the ground of the squib.

### CROSS-REFERENCE TO RELATED APPLICATIONS

This application is a national stage application under 35 U.S.C. §371 of PCT Application Number PCT/IB2011/002067 having an international filing date of Jul. 28, 2011, which designated the United States, which PCT application claimed the benefit of PCT Application Number PCT/IB2010/002569, filed Jul. 29, 2010, the entire disclosure of each of which are hereby incorporated herein by reference.

### FIELD OF THE INVENTION

The invention relates to an electrical circuit and a method of manufacturing such an electrical circuit. More particularly, the invention applies to a circuit and a method of manufacturing such an electrical circuit for Safety Restraint Systems (SRS) devices.

### BACKGROUND OF THE INVENTION

SRS devices are widespread in the automotive environment. They are often triggered by ignition. This ignition is controlled by an electrical signal.

Automotive vehicles are submitted to electromagnetic interferences. These interferences may induce current in conductors leading to SRS devices. Consequently, interferences may cause accidental ignitions of SRS devices.

Therefore, these conductors leading to the SRS devices have to be protected against electromagnetic interferences, in order to avoid their unwanted triggering. To this aim, a filtering element is usually used. For instance, U.S. Pat. No. 6,799,999 teaches the implementation of a filtering assembly including a printed circuit board and a filter circuit, preferably comprising a plurality of capacitors. The prior art filtering assembly is connected to the wire connection section of an airbag connector terminal.

### BRIEF SUMMARY OF THE INVENTION

An aim of the present invention is to propose an improved electrical circuit for EMI filtering, in particular for SRS devices which is adapted to work in common or differential mode, depending on the surrounding electrical environment,. Such an electrical circuit should further be compact enough to be housed in an automotive SRS connector.

Then, an electrical circuit is provided wherein a first conductor of the filtering element is connected to the ground of at least one of the control module and the squib.

With this feature, the filtering element (be it active or passive) connected to a ground, it is possible to dissipate the induced current(s) caused by the electromagnetic interference directly via a ground (dedicated) element of the car in which the electrical circuit is implemented.

The electrical circuit of the invention facilitates the electrical connection to the SRS device and therefore reduces the cost of assembly. It also provides added flexibility and increased functionality; depending on the electrical environment topography, it is possible to have a filter element capable to operate either in a common or a differential mode.

In some embodiments, one might also use one or more of the features defined in the dependent claims.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

Other characteristics and advantages of the invention will readily appear from the following description of three of its embodiments, provided as non-limitative examples, and of the accompanied drawings, in which:

FIG. 1 is a schematic exploded view of an electrical circuit in accordance with a first embodiment;

FIG. 2 is a schematic exploded view of an electrical circuit in accordance with a second embodiment; and

FIG. 3 is a schematic exploded view of an electrical circuit in accordance with a third embodiment.

On the different figures, the same references signs designate like or similar elements.

### DETAILED DESCRIPTION OF THE INVENTION

Referring to FIG. 1, the electrical circuit 2 according to the first embodiment of the invention comprises a control module 4 for generating a triggering signal, a squib 6 intended to trigger the actuation of a SRS device, such as an airbag, upon reception of the triggering signal, and an electrical connector 8 for connecting the control module 4 to the squib 6.

The control module 4 is, for example upon detection that a car crash is occurring, adapted to emit a differential triggering AC signal to the squib 6, through the electrical connector 8, for triggering the airbag. It comprises a conductor 39 electrically linked to a control module ground 10.

The squib 6 comprises a socket 12 having two conductive pins for receiving the triggering signal and one conductive pin connected to a squib ground 14. This later part comprises for example a metallic shell surrounding the squib 6.

The electrical connector 8 comprises a housing 16, contact pins 18 for transmitting the triggering signal, and a filtering element 20 electrically connected to the contact pins 18 for filtering a current possibly induced by electromagnetic interferences present in the vehicle.

The housing 16, typically made of an electrically insulating material, is adapted to carry the contact pins 18. It comprises, on a back face, a cylindrical plug 22 adapted to be mated into the socket 12 and, on the front face, three apertures 24, 26, 28 adapted to receive terminals of the contact pins 18.

The contact pins 18 comprise a first terminal 30, a second terminal 32 and a third terminal 34, for example made of deflectable L shaped fingers.

A first extremity 30A, 32A, 34A of each terminal is designed to be inserted in the apertures 24, 26, 28. According to this embodiment, the second extremity 32B of the second terminal 32 and the second extremity 34B of the third terminal 34 are electrically connected, for example by soldering or crimping, to a respective wire 36, 38 which extends to the control module 4.

In order to make sure that no any electromagnetic interference will trigger an unwanted deployment of the airbag, the filtering element 20 filters out from the signal transmitted on the second terminal 32 and on the third terminal 34, the signals due to these typical types of interferences.

To this end, the filtering element 20 comprises capacitor elements having a first conductor 40 designed to be connected to a ground, a second conductor 42 designed to receive the triggering signal, and a third conductor 44 designed to receive the filter signal.

Advantageously, according to the invention, the filtering element 20 is used to operate in a differential mode. But it can also be used in a common mode.

In the differential mode, the filtering element 20 is connected to a positive potential, a negative potential and to the ground. In the common mode, the filtering element 20 is only connected to a potential.

Such a filtering element is described in U.S. Pat. No. 7,162,388 herewith incorporated by reference. It can be for example a X2Y module.

In this embodiment, the first terminal 30 is connected to the squib ground 14 and the second terminal 32 transmits the triggering signal in the differential mode.

Due to the link between the first conductor 40 and the squib ground 14, the conductor 40 of the filtering element 20 is connected to a ground, in particular to the same ground as the squib 6. Advantageously, this link is made through the first terminal 30 of the electrical connector 8 i.e. over a short electrical path.

Alternatively, the filtering element 20 comprises capacitor elements and ferrite members.

Alternatively, the filter element 20 is soldered on a printed circuit board as shown on FIG. 12 of U.S. Pat. No. 7,162,388.

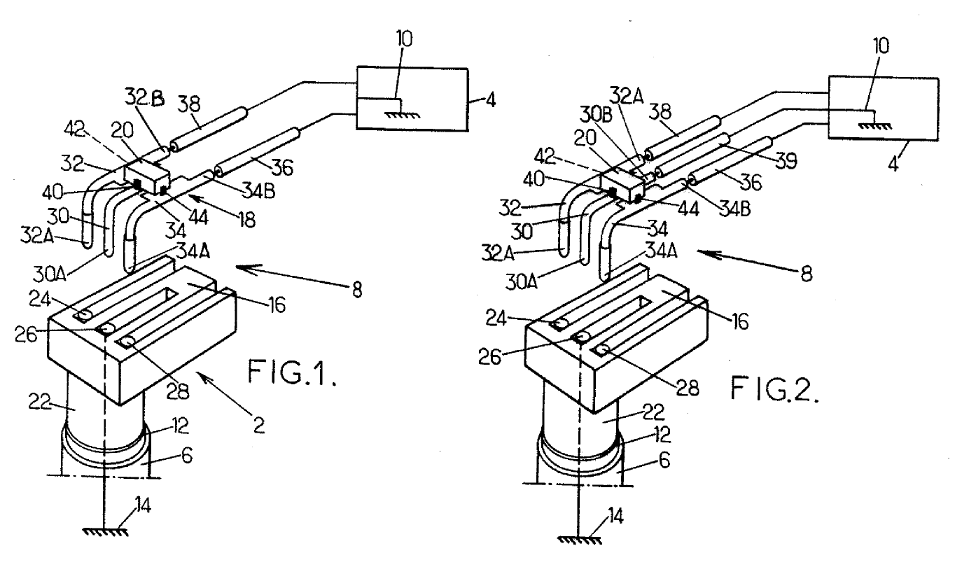

Alternatively, as shown on FIG. 2, the electrical connector 8 comprises an insulating block comprising three apertures 24, 26, 28 in which pins bonded to the wires 36, 38 and 39 are fitted.

The second extremity 30B of the first terminal 30 is electrically connected to the first conductor 40 as well as to the control module ground 10, through a wire 39.

Advantageously in this embodiment, the filtering element 20 is connected to a ground through both extremities 30A, 30B of the first terminal 30, in the differential mode.

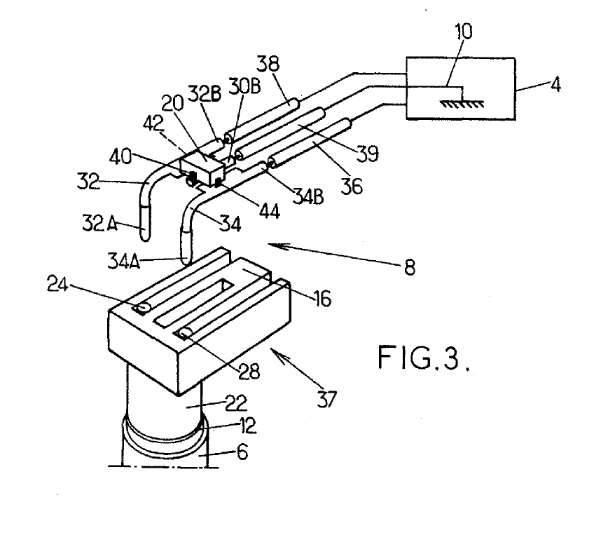

According to a third embodiment of the electrical circuit 37 on FIG. 3, the first conductor 40 of the filtering element 20 is connected only to the control module ground 10.

To this end, the second extremity 30B of the first terminal is connected to the control module ground 10 through the wire 39. The second extremity 30B of the first terminal is only in electrical contact to the conductor 40 of the filtering element 20.

In this embodiment, in the differential mode, the second terminal 32 and the third terminal 34 transmit the triggering signal and the first conductor 40 is electrically connected to the control module ground 10. In the common mode, the wire 39 is not connected to the ground.

The invention is also related to a method of manufacturing an electrical circuit for an automotive electrical system, comprising providing a filtering element for filtering trigger signal for a SRS device, the filtering element having a first conductor for connecting to a ground, providing a SRS squib intended to trigger the SRS device upon reception of said trigger signal, the squib having a ground, and connecting the first conductor to the ground of the squib.

Finally, the invention relates further to a method of manufacturing an electrical circuit for an automotive SRS system comprising providing a filtering element for filtering for filtering trigger signal for a SRS device, the filtering element having a first conductor for connecting to a ground, providing a control module generating said trigger signal, the control module having a ground, and connecting the first conductor to the ground of the control module.

1. An electrical circuit for an automotive electrical system, said circuit comprising:
a control module adapted to produce a triggering signal, the control module having a control module ground;
a filtering element for filtering the triggering signal, the filtering element having a first conductor;
a squib intended to trigger a Safety Restraint System (SRS) device upon reception of the triggering signal, the squib having a squib ground, wherein the first conductor is connected to at least one of the control module ground and the squib ground.

2. An electrical circuit for an automotive electrical system, said circuit comprising:
a filtering element for filtering a triggering signal, the filtering element having a first conductor; and
a squib intended to trigger a SRS device upon reception of the triggering signal, the squib having a squib ground, wherein the first conductor is connected to the squib ground.

3. The electrical circuit according to claim 2, wherein the filtering element comprises a second conductor and a third conductor; and wherein the electrical circuit further includes
a control module for generating the triggering signal, and
an electrical connector for connecting the control module to the squib; said electrical connector comprising a first terminal, a second terminal and a third terminal; the first terminal being electrically connected to the first conductor; the second terminal and the third terminal being electrically connected respectively to the second conductor and to the third conductor.

4. The electrical circuit (according to claim 3, wherein the control module has a control module ground; the second terminal being adapted to transmit the triggering signal from the control module to the squib.

5. The electrical circuit according to claim 3, wherein the second terminal and the third terminal are adapted to transmit the triggering signal from the control module to the squib.

6. The electrical circuit according to claim 3, wherein the filtering element is carried by the electrical connector.

7. The electrical circuit according to claim 1, wherein the filtering element comprises capacitor elements.

8. An electrical circuit for an automotive electrical system, said circuit comprising:
a control module adapted to produce a triggering signal, the control module having a control module ground;
a filtering element for filtering the triggering signal, the filtering element having a first conductor connected to the control module.

9. The electrical circuit according to claim 8, wherein the filtering element comprises a second conductor and a third conductor; and wherein the electrical circuit further includes
squib intended to trigger A SRS device upon reception of the triggering signal, the squib having a squib ground; and
an electrical connector for connecting the control module to the squib; said electrical connector comprising a first terminal, a second terminal and a third terminal; the first terminal being electrically connected to the first conductor; the second terminal and the third terminal being electrically connected respectively to the second conductor and to the third conductor.

10. The electrical circuit according to claim 9, wherein the squib has a ground; the second terminal being adapted to transmit the triggering signal from the control module to the squib.

11. The electrical circuit according to claim 9, wherein the second terminal and the third terminal are adapted to transmit the triggering signal from the control module to the squib.

12. An electrical circuit for an automotive electrical system, said circuit comprising:
control module adapted to produce a triggering signal, the control module having a control module ground;
filtering element for filtering the triggering signal, the filtering element having a first conductor; and
squib intended to trigger a SRS device upon reception of the triggering signal, the squib having a squib ground; the first conductor (40) is connected to the control module ground and to the squib ground.

13. A method of manufacturing an electrical circuit for an automotive electrical system, said method comprising:
providing a filtering element for filtering an triggering signal, the filtering element having a first conductor;
providing a squib intended to trigger a SRS device upon reception of said triggering signal, the squib having a squib ground; and
connecting the first conductor to the squib ground.

14. A method of manufacturing an electrical circuit for an automotive electrical system, said method comprising:
providing a filtering element for filtering an triggering signal, the filtering element having a first conductor for connecting to a ground;
providing a control module generating said triggering signal, the control module (4) having a control module ground; and
connecting the first conductor to the control module ground.
